(19) United States
(12) Patent Application Publication
(10) Pub. No.: US 2026/0205965 A1
(43) Pub. Date: Jul. 16, 2026

(54) BATTERY MANAGEMENT SYSTEM AND METHOD FOR SYNCHRONIZATION TIME THEREOF

(71) Applicant: Grace Connection Microelectronics Limited, ZHUBEI CITY (TW)

(72) Inventors: PEI-WEI CHEN, ZHUBEI CITY (TW); Chih-Hua Huang, ZHUBEI CITY (TW)

(73) Assignee: Grace Connection Microelectronics Limited, ZHUBEI CITY (TW)

(21) Appl. No.: 19/441,866

(22) Filed: Jan. 7, 2026

(30) Foreign Application Priority Data
Jan. 13, 2025 (TW) 114101336

(51) Int. Cl. H04W 56/00

(52) U.S. Cl. CPC H04W 56/00

(57) ABSTRACT

A method is provided by an aspect of the present disclosure, for calibrating synchronization time in each of multiple battery monitor devices connected in series in a battery management system. The method includes: receiving time data; obtaining a time offset according to the time data, and calibrating the synchronization time according to the time offset, a calibration value of master control device, or a delay value of each monitor device.

### CROSS REFERENCE

The present invention claims priority to TW114101336 filed on Jan. 13, 2025.

### BACKGROUND OF THE INVENTION

### Field of Invention

The present invention relates to a battery management system with a wireless daisy chain network topology, and more particularly to a method for calibrating a synchronizing time of each battery monitor device in the battery management system employing the wireless daisy chain network topology.

### Description of Related Art

To improve the efficiency of battery energy storage systems, battery packs in modern industrial and automotive energy storage applications are typically configured in a series connection. As the number of series-connected batteries increases, the accumulative voltage across the battery packs correspondingly increases. However, the battery energy storage system must rely on a battery management system (BMS) to monitor and collect information such as the voltage and temperature of each battery in the system, to maintain proper and safe operation.

To monitor the parameters of each battery, the battery management system (BMS) may include multiple monitor devices, with each battery being paired with one monitor device. When the connection of these monitor devices forms a wireless daisy chain network topology, a time deviation or lack of synchronization of the monitor devices may affect the voltage sensing of each battery at the same moment, thereby reducing the accuracy of battery management. Accordingly, there is a need for a technology capable of calibrating the synchronizing time of the monitor devices in a battery management system that employs a wireless daisy chain network topology, to ensure the correct performance of battery management.

### SUMMARY OF THE INVENTION

The present invention relates to a battery system and a battery communication system thereof, which utilize an RF coupler or an optical transceiver connected in a wireless daisy chain network topology to achieve time synchronization of the monitoring devices in a battery management system.

According to a first aspect of the present invention, a time synchronization method for a battery management system is provided. The battery management system includes a plurality of battery monitor devices connected in series, wherein the plurality of battery monitor devices are wirelessly connected in series to form a wireless daisy chain network topology. The time synchronization method of the battery management system includes receiving time data by a current stage device of the plurality of battery monitor devices. The time synchronization method further includes: the current stage device performing time synchronization based on the time data. The above steps are repeatedly performed to sequentially synchronize time for another battery monitor device of the plurality of battery monitor devices, until time synchronization of a last-stage battery monitor device of the plurality of battery monitor devices is completed.

According to a second aspect of the present invention, a battery management system is provided. The battery management system includes N battery monitor devices wirelessly connected in series to form a wireless daisy chain network topology, wherein N is a positive integer. A calibrated synchronization time of each of the N battery monitor devices can be obtained by an nth battery monitor device of the N battery monitor devices. The time data can be transmitted from a previous stage (n−1)th battery monitor device. The calibration of the synchronization time of each of the N battery monitor devices, can be further obtained by the nth battery monitor device by a time offset based on the time data, and the synchronization time of the nth battery monitor device can be calibrated by the time offset. The calibrated synchronization time of each of the N battery monitor devices can be forwarded by the nth battery monitor device in the time data to a next-stage (n+1)th battery monitor device. The above steps can be sequentially repeated for each of the N battery monitor devices until calibration of the last-stage Nth battery monitor device is completed, wherein n is an integer between 2 and N.

According to a third aspect of the present invention, a method is provided for calibrating a synchronization time between a master control device in a battery management system and N slave devices connected in series that are coupled to the master control device. The master control device and the N slave devices form a wireless daisy chain network topology, wherein N is a positive integer. The method includes transmitting master time data from the master control device to a first slave device of the N slave devices. The master time data includes a master control device transmission time corresponding to a time point at which the master control device transmits the master time data. The method further includes the first slave device receiving the master time data and obtaining a first reception time according to a time point at which the master time data is received. The method further includes the first slave device transmitting first time data to a second slave device of the N slave devices. The first time data include a first transmission time corresponding to a time point at which the first slave device transmits the first time data, the first reception time, a first calibration time, and the master control device transmission time. The first calibration time is zero. The method further includes the second slave device receiving the first time data and obtaining a second reception time according to a time point at which the first time data is received. The method further includes the second slave device transmitting second time data to a third slave device of the N slave devices.

The second time data include a second transmission time corresponding to a time point at which the second slave device transmits the second time data, the second reception time, a second calibration time, and the master control device transmission time. The second calibration time is a sum of first processing time and the first calibration time. The first processing time is a time difference between the first transmission time of the first slave device and the first reception time. The method further includes the third slave device receiving the second time data and obtaining a third reception time according to a time point at which the second time data is received. The method further includes the third slave device transmitting third time data to a fourth slave device of the N slave devices. The third time data include a third transmission time corresponding to a time point at which the third slave device transmits the third time data, the third reception time, a third calibration time, and the master control device transmission time. The third calibration time is a sum of a second processing time and the second calibration time, wherein the second processing time is a time difference between the second reception time and the second transmission time of the second slave device. The method further includes repeating the above steps for another one of the battery monitor devices of the rest slave devices of the N slave devices, until a last-stage Nth slave device of the N slave devices receives (N−1)th time data transmitted from an (N−1)th slave device and obtains an Nth reception time according to a time point at which the (N−1)th time data is received. Each of the N devices has a delay value. When each of the N devices receives corresponding time data, each of the N devices obtains a time offset and calibrates a synchronization time thereof according to the corresponding time offset, such that time synchronization of the N devices is achieved. The time offset used for calibrating time synchronization of an nth device of the N devices is an nth reception time minus a calibration value. The calibration value is a sum of the master control device transmission time, an nth calibration time, and a total delay value. The total delay value is equal to n multiplied by the delay value.

The objectives, technical details, features, and benefits of the present invention can be better understood with regard to the detailed description of the embodiments below, and with reference to the associated drawings.

### BRIEF DESCRIPTION OF THE DRAWINGS

FIG. 1 is a schematic diagram illustrating a battery system 1000 including a battery management system 200 according to multiple embodiments of the present invention.

FIG. 2A is a schematic diagram illustrating transmission of time data to battery monitor devices using a downlink information chain according to multiple embodiments of the present invention.

FIG. 2B is a schematic diagram illustrating a battery monitor device receiving and transmitting messages including time data according to multiple embodiments of the present invention.

FIG. 3A is a schematic diagram illustrating an exemplary format of time data according to multiple embodiments of the present invention.

FIG. 3B is a schematic diagram illustrating another exemplary format of time data according to multiple embodiments of the present invention.

FIG. 3C is a schematic diagram illustrating yet another exemplary format of time data according to multiple embodiments of the present invention.

FIG. 4 is a flowchart illustrating an exemplary procedure for calibrating synchronization time of a battery monitor device according to multiple embodiments of the present invention.

### DESCRIPTION OF THE PREFERRED EMBODIMENTS

The objectives, technical details, features, and effects of the present invention can be better understood with regard to the detailed description of the embodiments below, with reference to the associated drawings. The technical wordings/terms in this specification are based on a customary understanding of the art. In this specification, the interpretations of these wordings/terms are preferentially based on the description or the definition in this specification. Each embodiment of the present invention includes at least one technical feature. To the extent possible, a person having ordinary knowledge in the art may, as needed, select, combine, or modify some or all of the technical features in any one of the embodiments, within the spirit and scope of the present invention.

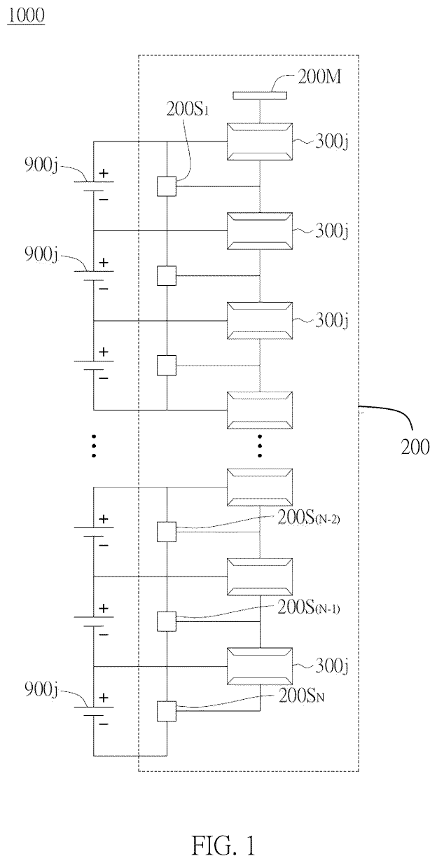

Referring to FIG. 1, a schematic diagram of a battery system 1000 and a battery management system 200 thereof according to an embodiment of the present invention is illustrated. The battery system 1000 includes a plurality of battery units 900j and the battery management system 200. The battery units 900j are connected in series. During operation of the battery system 1000, it is necessary to monitor the battery units 900j to confirm whether battery parameters such as temperature and voltage are within normal ranges. Accordingly, a battery monitor device is provided for each battery unit 900j (respectively corresponding to one of battery monitor devices 200S₁ (first stage) through 200S_{N} (last stage)) to perform monitoring. As shown in FIG. 1, the battery monitor devices include sequentially 200S₁ (first stage), . . . , 200S_{(N-2)}, 200S_{(N-1)}, and 200S_{N} (last stage).

As shown in FIG. 1, the battery management system 200 includes a master control device 200M, battery monitor devices 200S₁ through 200S_{N}, and a plurality of communication couplers 300j. The battery monitor devices 200S₁ through 200S_{N} may be referred to as slave devices relative to the master control device 200M. Each communication coupler 300j may be an optical coupler or an RF coupler, and is disposed between the master control device 200M and the first stage battery monitor device 200S₁, and between two adjacent battery monitor devices from the first stage battery monitor device 200S₁ to the last-stage battery monitor device 200S_{N}. The master control device 200M, and the battery monitor devices 200S₁ through 200S_{N} communicate with each other in pairs via the communication couplers 300j by whispering wireless communication, such that information, messages, or messages (downlink information chain) are sequentially transmitted forward from the battery monitor device 200S₁ toward the battery monitor device 200S_{N}, and confirmation messages (uplink information chain) are sequentially returned backward from the battery monitor device 200S_{N} to the battery monitor device 200S₁. As a result, the connection of the master control device 200M and the battery monitor devices 200S₁ through 200S_{N} forms a wireless daisy chain network topology, where N is a positive integer.

Since each of the battery monitor devices 200S₁ through 200S_{N} has a standard time, in order to synchronize the times of all stages of battery monitor devices in the battery management system 200, to ensure that the battery management system 200 can sense voltage values or other related battery parameters of the battery units 900j at the same time. The techniques provided by the present invention for calibrating synchronization time of each battery monitor device may transmit time data for synchronization or time calibration through the downlink information chain between battery monitor devices. The synchronization time (or internal circuit time) of a current stage battery monitor device (for example, the nth battery monitor device, where n is an integer between 2 and N) may be calibrated by a previous stage battery monitor device (the (n−1)th battery monitor device), or by the master control device 200M with respect to each battery monitor device.

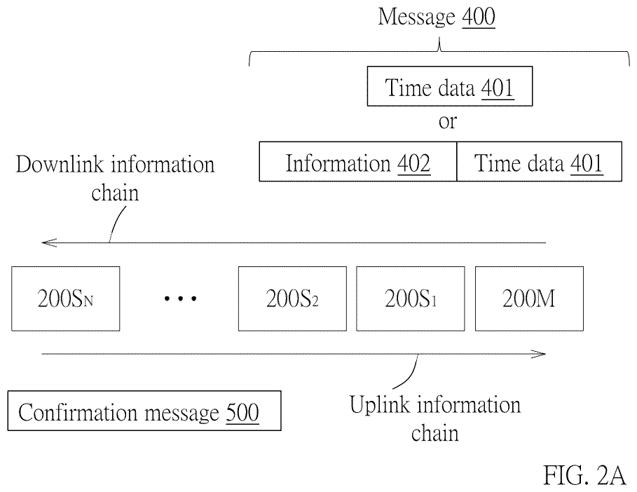

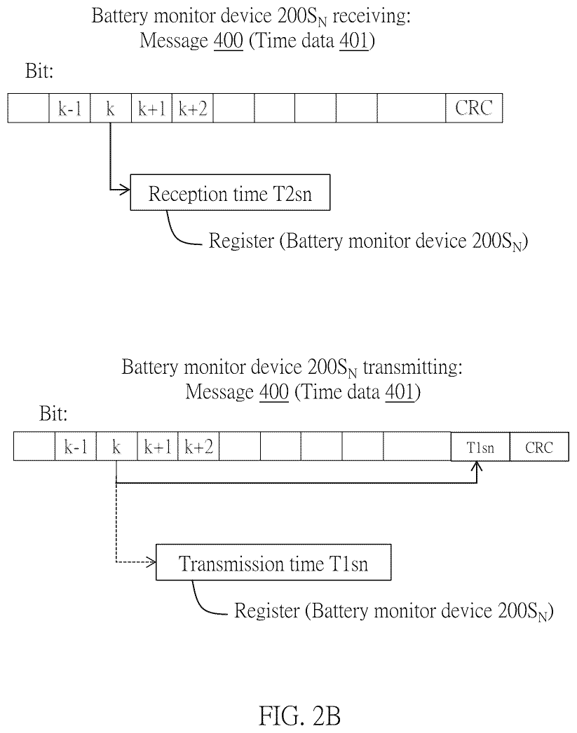

FIG. 2A shows a schematic diagram illustrating transmission of time data 401 to battery monitor devices 200S₁ through 200S_{N} by a downlink information chain according to multiple embodiments of the present invention. In an environment where the wireless daisy chain network topology has been established, a message 400 (which may include only time data 401, meaning the message 400 itself is the time data 401, or may include both information 402 and time data 401, meaning the time data 401 is embedded in general transmitted information) is sequentially transmitted from the master control device 200M to the first stage battery monitor device 200S₁, forwarded from the first stage battery monitor device 200S₁ to the second-stage battery monitor device 200S₂, and so on, until forwarded to the last-stage battery monitor device 200S_{N}. Thereafter, through the uplink information chain, confirmation messages 500 are sequentially returned from the last-stage battery monitor device 200S_{N} to the previous stage battery monitor device 200S_{(N-1)}, and so on, back to the master control device 200M. In this manner, all battery monitor devices (or slave devices) in the battery management system receive the time data 401 and may further use the time data 401 to calibrate their synchronization times (CurrentSysTime).

FIG. 2B is a schematic diagram illustrating a battery monitor device 200Sn receiving and transmitting the message 400 including time data 401 according to multiple embodiments of the present invention. When the message 400 includes information 402 and the time data 401, any one of the battery monitor devices 200S₁ through 200S_{N} (for example, battery monitor device 200Sn) may, via a built-in hardware timestamp function, automatically capture its internal current time point when receiving the kth bit of the message 400 including the time data 401, and store this time in a register as a designated reception time T2ₛₙ corresponding to reception of the time data 401.

When transmitting the message 400 including the time data 401, upon transmitting the kth bit including the time data 401, the internal current time point may likewise be automatically captured using the hardware timestamp function. This time is designated as a transmission time T1sn and included in the message 400, for example, before a cyclic redundancy check (CRC) (as shown in FIG. 2B), while also being stored in the register.

When time data 401 is received, the time data 401 includes a transmission time corresponding to a time point at which a previous stage battery monitor device (or slave device) transmitted the time data 401 (for example, the transmission time T1sn included in the time data 401 transmitted by battery monitor device 200Sₙ and received by battery monitor device 200S₍ₙ₊₁₎). A battery monitor device receiving this transmission time may designate it as a previous stage transmission time and store it in its register. It should be noted that the time data 401 transmitted by the master control device 200M may be regarded as master time data, and the transmission time corresponding to the time point at which the master control device transmits the master time data may be regarded as a master control device transmission time T1_{M}.

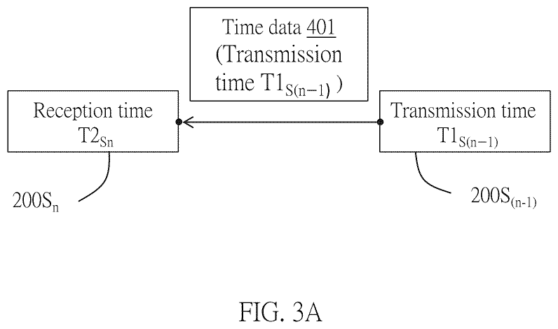

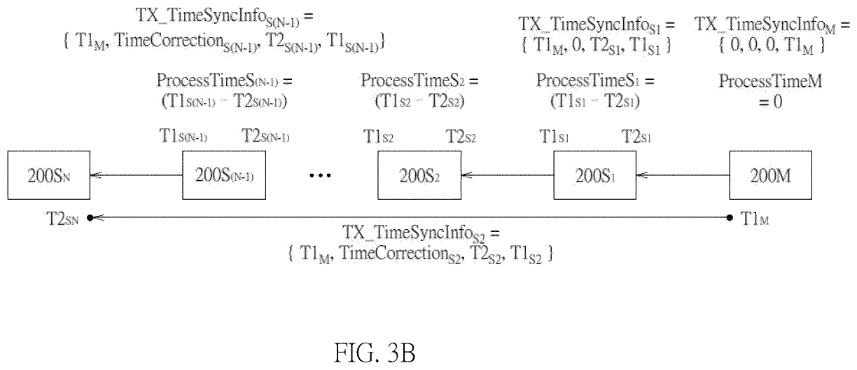

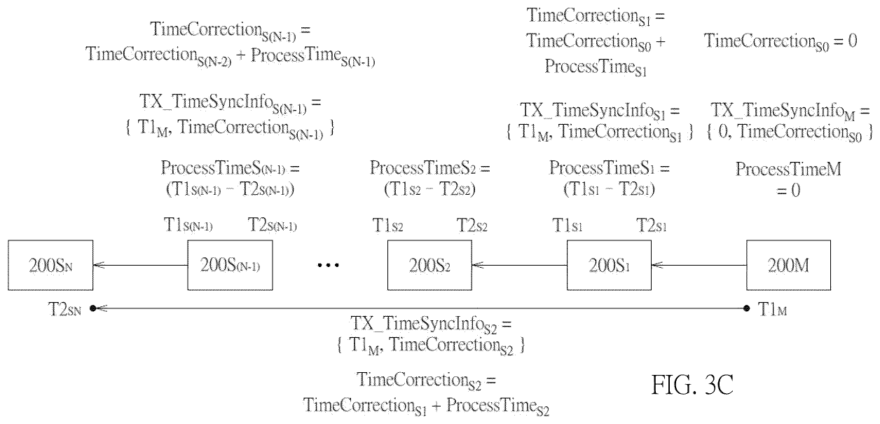

FIG. 3A is a schematic diagram illustrating an exemplary format of time data according to multiple embodiments of the present invention. As shown in FIG. 3A, when the battery monitor device 200Sₙ receives time data 401, embedded in another message or consisting solely of time data 401, the battery monitor device 200Sₙ may, as discussed above, obtain from the time data 401 a transmission time T1_{S(n-1)} of a previous stage battery monitor device 200S₍ₙ₋₁₎, and the current stage reception time T2ₛₙ corresponding to the time point at which the time data 401 is received. In this example, the time calibration message carries only the transmission time of the previous stage battery monitor device. Accordingly, the transmitted time data may be expressed as TX_TimeSyncInfo_{Sn}={T1_{Sn}}, and the received time data may be expressed as RX_TimeSyncInfo_{Sn}=TX_TimeSyncInfo_{S(n-1)}={T1_{S(n-1)}}.

In some embodiments, for each battery monitor device (i.e., each of the battery monitor devices 200S₁ through 200S_{N}), also referred to as each slave device, a synchronization time (CurrentSysTime_{Sn}) is calibrated by a time offset (TimeOffset_{Sn}) to obtain a calibrated synchronization time (CurrentSysTime_{Sn}′=TimeOffset_{Sn}+CurrentSysTime_{Sn}). When synchronization time is calibrated for a current stage battery monitor device by a previous stage battery monitor device (for example, calibration of the nth battery monitor device by the (n−1)th battery monitor device, where n is an integer between 2 and N), the time offset (TimeOffset_{Sn}) is equal to a reception time (T2_{Sn}) minus a transmission time (T1_{S(n-1)}) and a delay value (Delay). Accordingly, the time offset may be expressed as: TimeOffset_{Sn}=T2_{Sn}−(T1_{S(n-1)}+Delay). The delay value is a fixed constant that can be obtained through calculation and sensing, and may be used for calibrating the synchronization time of each battery monitor device as described above.

FIG. 3B is a schematic diagram illustrating another exemplary format of the time data according to multiple embodiments of the present invention. When the master control device 200M calibrates the synchronization time (or internal circuit time) of each battery monitor device; that is, when all battery monitor devices perform synchronization time calibration with respect to the master control device 200M, the master control device transmission time T1_{M} described above must be included. Accordingly, the time offset (TimeOffset_{Sn}) is equal to a reception time (T2_{Sn}) minus the master control device transmission time T1_{M}, a total delay value (Delay×n), and a calibration time (TimeCorrection_{Sn}). Thus, the time offset may be expressed as: TimeOffset_{Sn}=T2_{Sn}−(T1_{M}+Delay×n+TimeCorrection_{Sn}). Considering that additional data parameters such as T1_{M} and TimeCorrection_{Sn} is required, the time data in this example includes more data parameters. Accordingly, the transmitted time data may be expressed as: TX_TimeSyncInfo_{Sn}={T1_{M}, TimeCorrection_{Sn}=(TimeCorrection_{S(n-1)}+ProcessTime_{S(n-1)}), T2_{Sn}, T1_{Sn}}, where ProcessTime_{S(n-1)}=(T1_{S(n-1)}−T2_{S(n-1)}). The received calibration information may be expressed as: RX_TimeSyncInfo_{Sn}=TX_TimeSyncInfo_{S(n-1)}. From the above, theTimeCorrection_{Sn} is an accumulation of processing times ProcessTime_{S(n-1)} of previous stage devices. The processing time ProcessTime_{S(n-1)} of a previous stage device may be obtained by subtracting a previous stage reception time T2_{S(n-1)} from a previous stage transmission time T1_{S(n-1)}. Since the current stage reception time T2_{Sn} and the current stage transmission time T1_{Sn} are likewise included therein during forwarding. When a subsequent-stage device receives the time data, it may similarly calculate its processing time ProcessTime_{Sn} and accumulate it into the calibration time TimeCorrection_{Sn} to form TimeCorrection_{S(n+1)}, which is then included in TX_TimeSyncInfo_{S(n+1)}. The total delay value (Delay×n) is an accumulation of the delay values (Delay) of the battery monitor device 200Sₙ and all its previous stage devices (battery monitor devices 200S₁ through 200S₍ₙ₋₁₎), and is therefore represented as Delay multiplied by n.

Referring to FIG. 3B, when the master control device 200M transmits master time data (TX_TimeSyncInfo_{M}={0, 0, 0, T1_{M}}) to the first stage battery monitor device 200S₁, the time data received by the battery monitor device 200S₁ is RX_TimeSyncInfo_{S1}=TX_TimeSyncInfo_{M}, and the forwarded time data is TX_TimeSyncInfo_{S1}={T1_{M}, TimeCorrection_{S1}=0, T2_{S1}, T1_{S1}}. Since the processing time of the master control device does not need to be considered to receive the time data, the calibration time TimeCorrection_{S1} of the battery monitor device 200S₁ is zero. The reception time T2_{S1} and the transmission time T1_{S1} used for forwarding may be obtained, as described above, by automatically capturing internal time points corresponding to reception of the time data TX_TimeSyncInfo_{M} and transmission of the time data TX_TimeSyncInfoS1 using the hardware timestamp function of the battery monitor device 200S₁.

Next, the time data received by the next-stage battery monitor device 200S₂ is RX TimeSyncInfo_{S2}=TX_TimeSyncInfo_{S1}, and the forwarded time data is TX_TimeSyncInfo_{S2}={T1_{M}, TimeCorrection_{S2}=TimeCorrection_{S1}+ProcessTime_{S1}, T2_{S2}, T1_{S2}}. Since the calibration time TimeCorrection_{S1} of the battery monitor device 200S₁ is zero, the calibration time TimeCorrection_{S2} to be forwarded by the battery monitor device 200S₂ is equal to 0+ProcessTime_{S1}=T1_{S1}−T2_{S1}. Similarly, the reception time T2_{S2} and the transmission time T1_{S2} used for forwarding may be obtained by automatically capturing internal time points corresponding to reception of the time data TX_TimeSyncInfo_{S1} and transmission of the time data TX_TimeSyncInfo_{S2} using the hardware timestamp function of the battery monitor device 200S₂.

Similarly, the above steps may be repeatedly performed until the last-stage battery monitor device 200S_{N} receives the time data TX_TimeSyncInfo_{S(N-1)} transmitted by the previous stage battery monitor device 200S_{(N-1)}, thereby obtaining the information required for determining the time offset used to calibrate the synchronization time, that is, TimeOffset_{SN}=T2_{SN}−(T1_{M}+Delay×N+TimeCorrection_{SN}).

FIG. 3C is a schematic diagram illustrating yet another exemplary format of time data according to multiple embodiments of the present invention. In the example shown in FIG. 3C, when the master control device 200M calibrates the synchronization time (or internal circuit time) of each battery monitor device, namely, when all battery monitor devices perform synchronization time calibration with respect to the master control device 200M, the master control device transmission time T1_{M}, the calibration time TimeCorrection_{Sn}, and the processing time ProcessTime_{S(n-1)} of a previous stage device are likewise taken into consideration. With hardware support in each battery monitor device, the processing time ProcessTime_{S(n-1)} of a previous stage battery monitor device may be directly obtained by subtracting a reception time T2_{S(n-1)} corresponding to a time point at which time data RX_TimeSyncInfo_{S(n-1)} was previously received from a transmission time T1_{S(n-1)} corresponding to a time point at which the previous stage battery monitor device transmits the time data TX_TimeSyncInfo_{S(n-1)}. That is, ProcessTime_{S(n-1)}=T1_{S(n-1)}−T2_{S(n-1)}. Similarly, the processing time of a current stage device may be expressed as ProcessTime_{S(n)}=T1_{S(n)}−T2_{S(n)}. After obtaining the processing time ProcessTime_{S(n)}, and before transmitting the time data, the accumulated processing time, the calibration time TimeCorrection_{Sn} may be obtained by adding the processing time ProcessTime_{S(n)} of the current stage device to a previously accumulated calibration time TimeCorrection_{S(n-1)}. Accordingly, the time data TX_TimeSyncInfo_{Sn} transmitted by each battery monitor device may include only the master control device transmission time T1_{M} and the calibration time TimeCorrection_{Sn}, without including the reception time T2_{Sn} nor the transmission time T1_{Sn}. Thus, the transmitted time data may be expressed as: TX_TimeSyncInfo_{Sn}={T1_{M}, TimeCorrection_{Sn}}, where TimeCorrection_{Sn}=(TimeCorrection_{S(n-1)}+ProcessTime_{S(n-1)}), and ProcessTime_{S(n-1)}=(T1_{S(n-1)}−T2_{S(n-1)}) These values are calculated by hardware support in the previous stage device before transmitting the time data, and the calibration time TimeCorrection_{Sn} is directly included in the transmitted time data TX_TimeSyncInfo_{Sn}. Similarly, the received calibration information may be expressed as: RX_TimeSyncInfo_{Sn}=TX_TimeSyncInfo_{S(n-1)}. As in the example of FIG. 3B, since TimeCorrection_{Sn} is an accumulation of processing times ProcessTime_{S(n-1)} of the previous stage devices, and since the processing time ProcessTime_{S(n-1)} may be obtained from the time difference between a previous stage transmission time T1_{S(n-1)} and a previous stage reception time T2_{S(n-1)}. When the time data including TimeCorrection_{Sn} is forwarded together with information related to the reception time T2_{Sn} and the transmission time T1_{Sn} of the current stage device, a subsequent-stage device may likewise calculate the processing time ProcessTime_{S(n+1)} (based on the reception time T2_{S(n+1)} and transmission time T1_{S(n+1)}) and accumulate it into the calibration time TimeCorrection_{Sn} to form TimeCorrection_{S(n+1)} (included to TX_TimeSyncInfo_{S(n+1)}). Similarly, the total delay value (Delay×n) is an accumulation of delay values (Delay) of the battery monitor device 200Sₙ and all its previous stage devices (battery monitor devices 200S₁ through 200S₍ₙ₋₁₎), and is therefore represented as Delay multiplied by n. Likewise, the above steps may be repeated until the last-stage battery monitor device 200S_{N} receives the time data TX_TimeSyncInfo_{S(N-1)} transmitted by the previous stage battery monitor device 200S_{(N-1)}, thereby obtaining the information required for determining the time offset used to calibrate the synchronization time: TimeOffset_{SN}=T2_{SN}−(T1_{M}+Delay×N+TimeCorrection_{SN}).

Since the calibration time TimeCorrection_{Sn} at each stage is continuously accumulated, in a case where forwarding occurs due to message loss between two slave devices, the transmission time T1_{S(n-1)} will be delayed due to the forwarding operation, while the reception time T2_{S(n-1)} will not change. Accordingly, when calculating TimeCorrection_{Sn}=TimeCorrection_{S(n-1)}+T1_{S(n-1)}−T2_{S(n-1)}, the value of T1_{S(n-1)}−T2_{S(n-1)} increases and is included in the calibration time TimeCorrection_{Sn}, thereby improving the accuracy of synchronization time calibration.

Accordingly, based on the above-mentioned embodiments, when each battery monitor device receives time data, a time offset used for calibrating synchronization time may be obtained based on information included in the time data. Such information may include the master control device transmission time, the calibration time (calculated by the previous stage device), the reception time (of the previous stage device), and the transmission time (of the previous stage device); alternatively, the time data may include the master control device transmission time and a calibration time related to processing time that has been calculated in advance by a previous stage device. By the above information, the time offset required for calibrating the synchronization time may be determined.

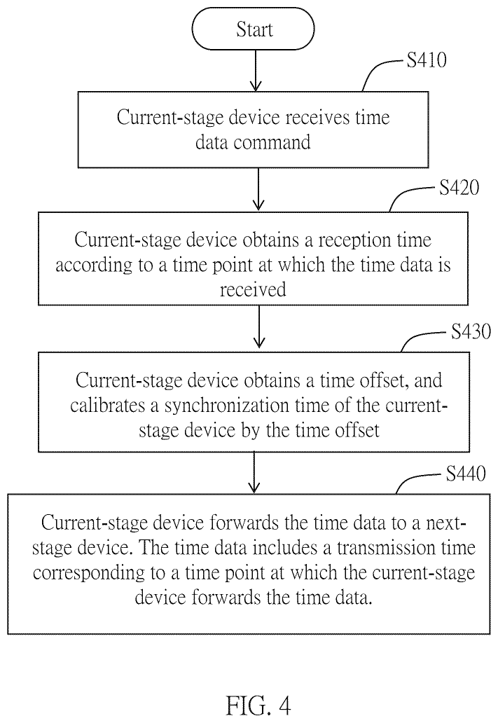

FIG. 4 is a flowchart illustrating an exemplary procedure for calibrating synchronization time performed by a battery monitor device according to multiple embodiments of the present invention. In step S410, a current stage device (for example, a battery monitor device 200Sₙ) of a plurality of battery monitor devices receives time data. The time data may be transmitted by a previous stage device located upstream of the current stage device (for example, a battery monitor device 200S₍ₙ₋₁₎) or by a master control device (such as the master control device 200M shown in FIG. 1). The time data includes a transmission time corresponding to a time point at which the time data is transmitted (for example, T1_{S(n-1)}). In step S420, the current stage device obtains a reception time (for example, T2_{Sn}) according to a time point at which the time data is received, and designates the transmission time included in the time data as a previous stage transmission time (T1_{S(n-1)}, which is different from T1_{Sn}). In step S430, the current stage device obtains a time offset (for example, TimeOffset_{Sn}), and calibrates a synchronization time (for example, CurrentSysTime_{Sn}) of the current stage device by the time offset (for example, CurrentSysTime_{Sn}′=TimeOffset_{Sn}+CurrentSysTime_{Sn}). The time offset is equal to the reception time minus a calibration value (for example, TimeOffset_{Sn}=T2_{Sn}−CV_{Sn}). The calibration value is related to the previous stage transmission time and a delay value (Delay). In step S440, the current stage device forwards the time data to a next-stage device (for example, the battery monitor device 200S₍ₙ₊₁₎). The time data includes a transmission time (T1_{Sn}) corresponding to a time point at which the current stage device forwards the time data.

As described above, according to the present invention, in a battery management system with a wireless daisy chain network topology, a master control device periodically or non-periodically transmits messages including time data, or transmits time data, such that each battery monitor device in the wireless daisy chain network topology calibrates its synchronization time based on the time data. Accordingly, each battery monitor device may sense battery parameters, such as battery voltage, at the same time, thereby improving the stability and accuracy of the battery management system (BMS).

The foregoing disclosure provides various features for implementing some embodiments or examples of the present invention. Specific examples of components and configurations described above (such as numerical values or names) are provided to simplify and illustrate some embodiments of the present invention. Substantially, such components and configurations are merely exemplary and are not intended to be limiting. In addition, some embodiments of the present invention may reuse reference numerals and/or letters across different examples. Such reuse is for the sake of simplicity and clarity and does not, by itself, indicate any relationship among the various embodiments and/or configurations discussed.

Although the present invention has been described above with reference to embodiments, it is not intended to limit the present invention. Persons having ordinary skill in the art may make various modifications and refinements without departing from the spirit and scope of the present invention. Accordingly, the scope of protection of the present invention shall be defined by the claims.

What is claimed is:

1. A time synchronization method for a battery management system, wherein the battery management system includes a plurality of battery monitor devices connected in series, and the battery monitor devices form a wireless daisy chain network topology via wireless serial coupling, the time synchronization method of the battery management system including:
(1) receiving time data, by one of the battery monitor devices serving as a current stage device;
(2) performing time synchronization according to the time data, by the current stage device; and
(3) repeating steps (1) and (2) sequentially for another one of the battery monitor devices of the rest slave devices, until time synchronization is completed at the last stage one of the plurality of battery monitor devices;
wherein, the time data includes a transmission time corresponding to a time point at which the time data is transmitted, and each of the battery monitor devices has a delay value; and
wherein, the steps of performing time synchronization by the current stage device according to the time data further, include:
(a) the current stage device obtaining a reception time according to a time point at which the time data is received, and designating the transmission time included in the time data as a previous stage transmission time;
(b) the current stage device forwarding the time data to a next-stage device connected next to the current stage device, the time data including a transmission time corresponding to a time point at which the current stage device forwards the time data;
(c) the current stage device obtaining a time offset by subtracting the previous stage transmission time and the delay value from the reception time, and calibrating a synchronization time of the current stage device according to the time offset; and
(d) repeating steps (a) through (c) sequentially for another one of the battery monitor devices of the rest slave devices, until calibration of the synchronization time of the last-stage battery monitor device is completed.

2. The time synchronization method of the battery management system according to claim 1, wherein a first stage one of the battery monitor devices serves as a master control device; and the time data transmitted by the master control device includes a master control device transmission time;
wherein, the time data received and forwarded by each of the plurality of battery monitor devices includes the master control device transmission time, a calibration time, the transmission time, and the reception time;
wherein, the calibration time is a sum of the previous stage processing times of the battery monitor devices, the transmission time corresponds to a time point at which the time data is transmitted, the reception time corresponds to a time point at which the time data transmitted by a previous stage one of the battery monitor devices is received; and each of the battery monitor devices has a delay value;
and wherein, the steps of performing time synchronization by the current stage device according to the time data further includes:
(d) the current stage device respectively designating the calibration time, the transmission time, and the reception time in the time calibration information, as a previous stage calibration time, the previous stage transmission time, and a previous stage reception time; and the current stage device obtaining a corresponding current stage reception time according to a time point receiving the time data;
(e) the current stage device obtaining a time offset by subtracting a sum of the master control device transmission time, an accumulated delay value, and the calibration time, from the reception time; and the current stage device calibrating a synchronization time of the current stage device according to the time offset, wherein the accumulated delay value is a cumulative sum of the delay values associated with each of the battery monitor devices and its previous stages device;
(f) the current stage device obtaining the previous stage processing time by subtracting the previous stage reception time from the previous stage transmission time;
(g) the current stage device obtaining a current stage calibration time in the time calibration information used for forwarding by adding the previous stage processing time and the previous stage calibration time;
(h) the current stage device forwarding the time data to the next-stage device connected next to the current stage device, the time data including the master control device transmission time, the current stage calibration time, a current stage transmission time corresponding to a time point at which the current stage device forwards the time data, and the current stage reception time; and
(i) repeating steps (d) through (h) sequentially for another one of the battery monitor devices of the rest slave devices, until calibration of the synchronization time of the last-stage device is completed.

3. The time synchronization method of the battery management system according to claim 1, wherein a first stage one of the battery monitor devices serves as a master control device, and the time data transmitted by the master control device includes a master control device transmission time;
wherein the time data received and forwarded by each of the other battery monitor devices, include the master control device transmission time and a calibration time; and
wherein, the calibration time is obtained by each of the plurality of battery monitor devices to accumulate the processing times of all previous stage devices and a processing time of the battery monitor device; the processing time is obtained by subtracting a reception time of time data transmitted by a previous stage device, from a transmission time at which the time data is transmitted by the battery monitor device; and, each of the plurality of battery monitor devices has a delay value;
wherein the step of performing time synchronization by the current stage device according to the time data, further includes:
(j) the current stage device designating the calibration time in the time calibration information as a previous stage calibration time, and obtaining a corresponding current stage reception time according to a time point receiving the time data;
(j′) the current stage device obtaining a time offset by subtracting a sum of the master control device transmission time, an accumulated delay value, and the calibration time from the reception time; and the current stage device calibrating a synchronization time of the current stage device according to the time offset, wherein the accumulated delay value is a cumulative sum of the delay values associated with each of the battery monitor devices and its previous stages device;
(k) the current stage device forwarding the time data to a next-stage device, the time data including the master control device transmission time and a current stage calibration time, wherein the current stage calibration time is obtained by adding the previous stage calibration time and the current stage processing time, wherein the current stage processing time is obtained by subtracting the current stage reception time from a current stage transmission time corresponding to a time point at which the current stage device forwards the time data; and
(l) repeating steps (j) through (k) sequentially for another one of the battery monitor devices of the rest slave devices, until calibration of the synchronization time of the last-stage device is completed.

4. The time synchronization method of the battery management system according to claim 1, wherein each of the battery monitor devices senses a voltage value of a corresponding battery in the battery management system according to the calibrated synchronization time.

5. A battery management system including:
N battery monitor devices wirelessly connected in series, to form a wireless daisy chain network topology, where N is a positive integer;
wherein the calibration of a synchronization time of each of the N battery monitor devices includes:
(1) an nth device of the N battery monitor devices receiving time data transmitted by an (n−1)th device serving as a previous stage of the nth device;
(2) the nth device obtaining a time offset according to the time data, and calibrating a synchronization time of the nth device according to the time offset;
(3) the nth device forwarding the time data to an (n+1)th device serving as a next stage of the nth device; and
(4) repeating steps (1) through (3) sequentially for another one of the battery monitor devices of the rest slave devices, until calibration is completed at an Nth battery monitor device serving as the last stage device;
wherein n is an integer from 2 to N.

6. The battery management system according to claim 5, wherein the time data includes a transmission time corresponding to a time point at which the (n−1)th device transmits the time data, and each of the N battery monitor devices has a delay value;
the steps in which the nth device obtains the time offset according to the time data include:
the nth device obtaining a reception time according to a time point at which the time data is received, and designating the transmission time in the time data as a previous stage transmission time;
obtaining the time offset by subtracting the previous stage transmission time and the delay value from the reception time, and calibrating a synchronization time of the nth device by the time offset.

7. The battery management system according to claim 5, wherein a first stage one of the N battery monitor devices serves as a master control device, and the time data transmitted by the master control device includes a master control device transmission time;
wherein, the time data received and forwarded by each of the N battery monitor devices, include the master control device transmission time, a calibration time, a transmission time, and a reception time;
wherein, the calibration time is a sum of the previous stage processing times of each of the N battery monitor devices, the transmission time corresponds to a time point at which the time data is transmitted, the reception time corresponds to a time point at which the time data transmitted by a previous stage device is received, and each of the N battery monitor devices has a delay value;
wherein the steps of performing time synchronization by the nth device according to the time data, further include:
the nth device designating the calibration time, the transmission time, and the reception time in the time calibration information, as a previous stage calibration time, a previous stage transmission time, and a previous stage reception time, respectively; and the nth device obtaining a current stage reception time corresponding to a time point receiving the time data;
the nth device obtaining a time offset by subtracting a sum of the master control device transmission time, an accumulated delay value and the calibration time, from the reception time; and the nth device calibrating a synchronization time of the nth device according to the time offset, wherein the accumulated delay value is a cumulative sum of the delay values of the N battery monitor devices and their previous stage devices.

8. The battery management system according to claim 7, wherein forwarding of the time data by the nth device to the (n+1)th device further includes:
the nth device obtaining a previous stage processing time by subtracting the previous stage reception time from the previous stage transmission time;
the nth device obtaining a current stage calibration time in the time calibration information for forwarding by adding the previous stage calibration time to the previous stage processing time; and
the nth device forwarding the time data to the (n+1)th device, the time data including the master control device transmission time, the current stage calibration time, a current stage transmission time corresponding to a time point at which the nth device forwards the time data, and the nth reception time.

9. The battery management system according to claim 5, wherein a first stage one of the N battery monitor devices serves as a master control device, and the time data transmitted by the master control device includes a master control device transmission time;
the time data received and forwarded by each of the N battery monitor devices includes the master control device transmission time and a calibration time;
wherein, the calibration time is obtained by each of the N battery monitor devices, by accumulating the processing times of all previous stage devices and a current stage processing time; the processing time is obtained by subtracting a reception time of time data transmitted by a previous stage device of each of the N battery monitor devices, from a transmission time at which the time data is forwarded by each of the N battery monitor devices; and each of the N battery monitor devices has a delay value;
wherein, the steps of performing time synchronization by the nth device according to the time data further include:
the nth device designating the calibration time in the time calibration information as a previous stage calibration time, and obtaining a current stage reception time corresponding to a time point at which the nth device receiving the time data; and
the nth device obtaining a time offset by subtracting a sum of the master control device transmission time, an accumulated delay value, and the calibration time from the reception time; and the nth device calibrating a synchronization time of the nth device according to the time offset, wherein the accumulated delay value is a cumulative sum of the delay values associated with each of the battery monitor devices and its previous stages device.

10. The battery management system according to claim 9, wherein forwarding of the time data by the nth device to the (n+1)th device includes:
the nth device forwarding the time data to the (n+1)th device, the time data including the master control device transmission time and a current stage calibration time, wherein the current stage calibration time is obtained by adding a previous stage calibration time to a current stage processing time, the current stage processing time being obtained by subtracting the current stage reception time from a current stage transmission time corresponding to a time point at which the nth device forwards the time data.

11. The battery management system according to claim 5, wherein each of the N battery monitor devices senses a voltage value of a corresponding battery in the battery management system according to the calibrated synchronization time.

12. A time synchronization method for a battery management system for calibrating a synchronization time of a master control device and N slave devices connected in series and coupled to the master control device, wherein a connection of the master control device and the N slave devices form a wireless daisy chain network topology, and N is a positive integer, the time synchronization method including:
(1) the master control device transmitting master time data to a first slave device of the N slave devices, the master time data including a master control device transmission time corresponding to a time point at which the master control device transmits the master time data;
(2) the first slave device receiving the master time data and obtaining a first reception time according to a time point at which the master time data is received;
(3) the first slave device transmitting first time data to a second slave device of the N slave devices, the first time data including a first transmission time corresponding to a time point at which the first slave device transmits the first time data, the first reception time, a first calibration time, and the master control device transmission time, wherein the first calibration time equals zero;
(4) the second slave device receiving the first time data and obtaining a second reception time according to a time point at which the first time data is received;
(5) the second slave device transmitting second time data to a third slave device of the N slave devices, the second time data including a second transmission time corresponding to a time point at which the second slave device transmits the second time data, the second reception time, a second calibration time, and the master control device transmission time, wherein the second calibration time is a sum of first processing time and the first calibration time, and the first processing time is obtained by subtracting the first reception time from the first transmission time;
(6) the third slave device receiving the second time data and obtaining a third reception time according to a time point at which the second time data is received;
(7) the third slave device transmitting third time data to a fourth slave device of the N slave devices, the third time data including a third transmission time corresponding to a time point at which the third slave device transmits the third time data, the third reception time, a third calibration time, and the master control device transmission time, wherein the third calibration time is a sum of a second processing time and the second calibration time; and the second processing time is obtained by subtracting the second reception time from the second transmission time; and
(8) repeating steps (1) through (7) for another one of the battery monitor devices of the rest slave devices of the N slave devices, until an Nth slave device serving as a last-stage slave device of the N slave devices receives (N−1)th time data transmitted by an (N−1)th slave device of the N slave devices and obtains an Nth reception time according to a time point at which the (N−1)th time data is received, wherein each of the N devices has a delay value;
wherein when each of the N devices receives its corresponding time data, each of the N devices obtains a time offset and calibrates its synchronization time according to the corresponding time offset such that the times of the N devices are synchronized;
wherein, the time offset used for synchronizing and calibrating a synchronization time of an nth device of the N devices, is equal to an nth reception time minus a calibration value;
wherein the calibration value is a sum of the master control device transmission time, an nth calibration time, and a total delay value; and
wherein the total delay value equals n multiplied by the delay value.
